(19) United States
(12) Patent Application Publication
(10) Pub. No.: US 2013/0050765 A1
(43) Pub. Date: Feb. 28, 2013

(54) METHOD AND APPARATUS FOR DOCUMENT AUTHENTICATION USING IMAGE COMPARISON ON A BLOCK-BY-BLOCK BASIS

(71) Applicants: Xiaonong Zhan, Foster City, CA (US); Wei MING, Cupertino, CA (US); Songyang YU, Foster City, CA (US)

(72) Inventors: Xiaonong Zhan, Foster City, CA (US); Wei MING, Cupertino, CA (US); Songyang YU, Foster City, CA (US)

(73) Assignee: KONICA MINOLTA LABORATORY U.S.A., INC., San Mateo, CA (US)

(21) Appl. No.: 13/223,303

(22) Filed: Aug. 31, 2011

(51) Int. Cl. H04N 1/40; G06K 9/34; G06K 9/68

(52) U.S. Cl. 358/3.01; 382/218; 358/443; 382/173

(57) ABSTRACT

A document authentication method using block-by-block image comparison is disclosed. An image of an original document and an image of a target document are each segmented into multiple blocks corresponding to paragraphs of text. A first block in the original image is used to search the target image to find a corresponding first block using a cross-correlation method. The position mapping for the first block of the target image is calculated and alterations are detected. Then, for each subsequent block of the original image, a corresponding block of the target document is identified based on the position of the subsequent block of the original image relative to the first block of the original image and the position mapping for the first block of the target image. The corresponding subsequent blocks of the original and target images are compared to detect alterations using a method other than cross-correlation.

### BACKGROUND OF THE INVENTION

1. Field of the Invention

This invention relates to a document authentication method by image comparison, and in particular, by image comparison on a block-by-block basis.

2. Description of Related Art

In situations where an original document, either in electronic form or in hardcopy form, is printed or copied to produce a copied document in hardcopy form, and the copied document is distributed and circulated, there is often a need to determine whether a purported true copy (referred to as the target document in this disclosure) is authentic, i.e., whether the copied document has been altered while it was in circulation. A goal in many document authentication methods is to detect what the alterations (additions, deletions) are. Alternatively, some document authentication methods determine whether or not the document has been altered, without determining what the alterations are.

Various types of document authentication methods are known. One type of document authentication method performs a digital image comparison of a scanned image of the target document with an image of the original document. In such a method, the image of the original document is stored in a storage device at the time of printing or copying. Later, the target document is scanned, and the stored image of the original document is retrieved from the storage device and compares with the image of the target document. In addition, certain data representing or relating to the original document, such as a document ID, is also stored in the storage device. The same data is encoded in barcodes which are printed on the copied document when the copy is made, and can be used to assist in document authentication.

Often, the image of the target document (the target image) contains various distortions due to the document having been copied and/or scanned. These distortions may include scaling (size enlargement or reduction), rotation, and/or shift of the image as compared to the image of the original document (the original image). Thus, the target image needs to be corrected for these distortions before image comparison. This process may be referred to as image registration or alignment. Correction for scaling distortion is also referred to as resizing; correction for rotation distortion is also referred to as deskew. One image registration method uses cross-correlation of the target and original images to calculate a global registration. Such calculation can be computationally intensive.

### SUMMARY

The present invention is directed to an improved image comparison method and related apparatus that substantially obviates one or more of the problems due to limitations and disadvantages of the related art.

An object of the present invention is to provide an improved image comparison method useful for comparing images that represent documents containing text.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a document authentication method implemented in a data processing system, which includes: (a) obtaining an original image representing an original document; (b) segmenting the original image into a plurality of blocks to generate layout information, wherein the layout information includes positions of the plurality of blocks; (c) obtaining a target image representing a target document; (d) segmenting the target image into a plurality of blocks; (e) for a first block among the plurality of blocks of the original image: (e1) searching the target image to identify a first block of the target image corresponding to the first block of the original image; (e2) calculating a position mapping for the first block of the target image; and (e3) detecting any alterations in the first block of the target image; and (f) for each subsequent block among the plurality of blocks of the original image: (f1) identifying a subsequent block of the target image corresponding to the subsequent block of the original image based on a position of the subsequent block of the original image relative to the first block of the original image obtained from the layout information and the position mapping for the first block of the target image calculated in step (e2); (f2) comparing the subsequent block of the original image and the subsequent block of the target image to detect any alterations in the subsequent block of the target image.

In another aspect, the present invention provides a computer program product comprising a computer usable non-transitory medium (e.g. memory or storage device) having a computer readable program code embedded therein that causes a data processing apparatus to perform the above methods or parts thereof.

It is to be understood that both the foregoing general description and the following detailed description are exemplary and explanatory and are intended to provide further explanation of the invention as claimed.

### BRIEF DESCRIPTION OF THE DRAWINGS

FIGS. 1 and 2 schematically illustrate a document authentication method according to an embodiment of the present invention. FIG. 1 illustrates a document registration stage and FIG. 2 illustrates an authentication stage of the method.

FIG. 3 schematically illustrates the image comparison step of the authentication stage.

FIG. 4 illustrates a system in which embodiments of the present invention may be implemented.

### DETAILED DESCRIPTION OF PREFERRED EMBODIMENTS

Embodiments of the present invention provide an image comparison method useful for authenticating documents containing text. Both the original image representing the original document and the target image representing the target document are segmented into a number of relatively large blocks, each block being a sub-image of the respective image. For example, the images may be segmented into multiple blocks each corresponding to a paragraph of text in the document. Then, a first block in the original image is used to search the target image to find a corresponding first block, for example, by using a cross-correlation method. In this step, the position mapping for the first block in the target image is calculated, and the two blocks are compared to find any alterations. After the first block is processed, subsequent blocks of the original and target images are identified based on relative position information and may be compared using a method other than cross-correlation.

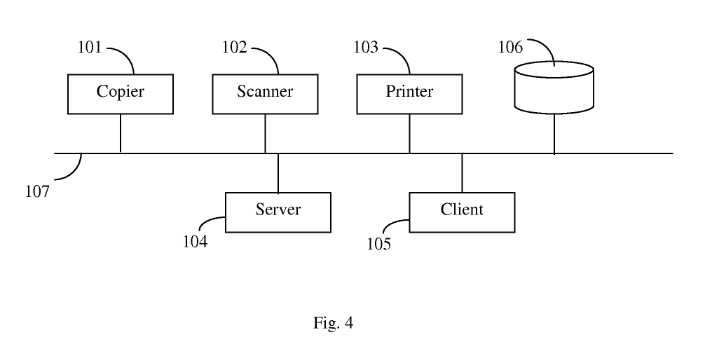

FIG. 4 illustrates a system that may be used to implement the document authentication method according to embodiments of the present invention. The system includes one or more copiers 101, scanners 102, printers 103, servers 104, mass storage devices 106, etc. It may also include other components such as one or more client computers 105, etc. The copiers, scanners, or printers may be all-in-one devices, i.e., devices that combine a printing section and scanning section in a single device and can perform scanning, printing, and copying functions. Each of the copiers 101, scanners 102, printers 103, servers 104, clients 105 etc. may include a processor with associated memories which can carry out data processing functions by executing programs stored in the memory (these devices or a collection of them may be more generally referred to as data processing apparatus or system). These components are connected to each other by a network 107 and may be located at distributed locations. The copier 101 or printer 103 may be used to make a copy of the original document, and the scanner 102 or the copier 101 may be used to scan a copied document (target document), as will be described later. Various parts of the authentication method may be carried out by the server 104, the copier 101, the printer 103, the scanner 102, or the client 105, etc.

The document authentication method according to embodiments of the present invention includes a document registration stage and an authentication stage. Note that “document registration” should not be confused with “image registration.” Document registration refers to storing (registering) the images of the original documents with the system for later retrieval; “image registration” refers to aligning one image with another. In the document registration stage, a printer 103 or copier 101 makes a hardcopy (i.e. on a physical medium such a paper) copy of an original document which may be in electronic or hardcopy form. An image of the original document (referred to as the original image) is generated in the document registration stage. If the original document is in electronic form, the original image may be generated from the original electronic document by the server 104 or the printer 103. If the original document is in hardcopy form and a copy is made by a copier 101, the copier scans the original hardcopy document to generate the original image and then print a copy from the scanned image. The original image is processed by a data processing apparatus and the resulting data is stored in the storage device 106. Later, in the authentication stage, a user may submit a copied document (the target document) for authentication by scanning the target document using a scanner 102 or copier 101, and causing a data processing apparatus to retrieve the stored data from the storage device 106 and to perform image comparison.

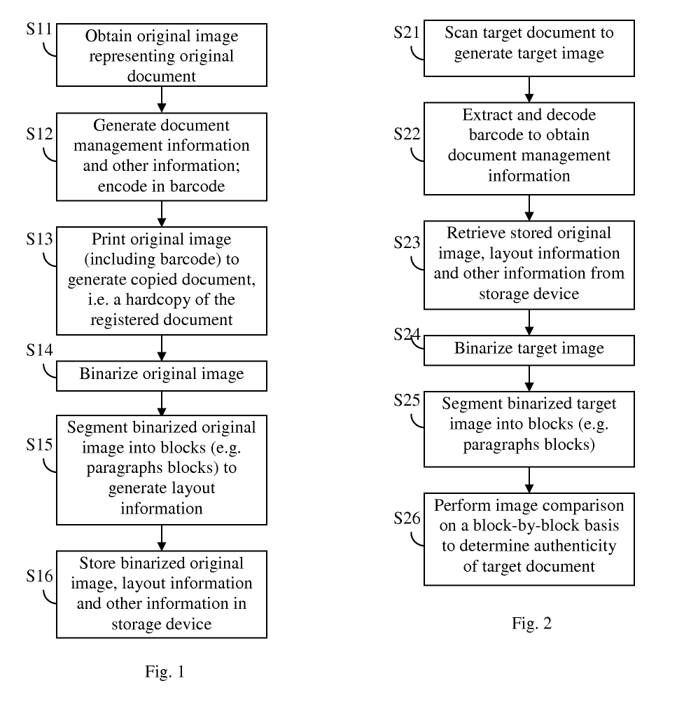

The document registration stage is described with reference to FIG. 1. First, a digital image representing the original document (the original image) is obtained (step S11). A hardcopy copy of the original document is generated by printing (step S13). In addition, document management information, such as document ID, is generated and encoded in barcode (step S12), which is also printed on the hardcopy document in step S13. The document ID will aid in retrieval of the stored images during the authentication stage. Optionally, other document management information may also be encoded in the bar code, such as time of creation of the copy, identity of the user who created the copy, etc., but this is not critical because such information can be stored in the storage device along with the image if desired.

If the original image is a grayscale image (as is typically the case when it is generated by scanning), the image is binarized (step S14). This step is omitted if the original image is already a binary image.

Then, the binarized original image is segmented into a number of relatively large blocks (step S15). For example, the original image may be segmented into paragraph blocks each corresponding to a paragraph of text. Each block is defined by its bounding box, which is a box (preferably rectangular) that bounds the corresponding text from all sides. If the document contains image or graphic objects, each such object may be a block. The segmentation result, i.e. the positions of the blocks, may be referred to as layout information as it reflects the general layout of the original document.

Many methods can be used to accomplish image segmentation of a document that includes text. In one method, a horizontal histogram (or horizontal projection) is generated by plotting, along the vertical axis, the number of non-white pixels in each row of pixels. Such a horizontal histogram will tend to have segments of low values corresponding to white spaces between lines of text, and segments (approximately equal width) of higher values corresponding to lines of text. Such histograms can therefore be used to identify line units for document segmentation. Further, if paragraph spacing is different from line spacing in the document, block (e.g. paragraph) units can be identified from such histograms (where larger gaps in the histogram would indicate paragraph breaks and smaller gaps in the histogram would indicate line breaks). Additional starting and ending information of lines may be helpful for block extraction. Further, in the case of multiple objects and complicated layout design, the existence of different types of objects in some area can be identified by analyzing the distribution of the histogram, and then data block can be extracted by analyzing vertical projection in that area.

In another document segmentation method, a morphological dilation operation is performed on the image, so that nearby characters merge into dark blocks corresponding to word units. Dilation is a well-known technique in morphological image processing which generally results in an expansion of the dark areas of the image. Once the characters are merged into word units, they can be further grouped to form line units and paragraph units.

In another document segmentation method, connected image components (e.g. connected groups of pixels in the case of a binary image) may be identified as corresponding to characters, and character units are formed from these connected image components. Once character units are formed, they can be grouped to form word units, line units, and paragraph units based on their relative spatial positions.

Other document segmentation methods also exist. Some such methods are knowledge based, which uses knowledge of document structure to segment the image.

After segmentation, the binarized original image is stored in a storage device along with the layout information (step S16). The image and related information are stored in association with the document management information, such as the document ID, to facilitate image retrieval during the authentication stage. The stored image along with the associated information may be referred to as the registered document. The hardcopy generated by step S13 is referred to as a copy of the registered document.

In the document registration stage, steps S14 to S16 may be performed by the copier or printed, in which case the copier or printed can transmit the binarized image and layout information to the server or store it directly in the storage device; or they may be performed by the server, in which case the copier or printer will transmit the original image to the server. Step S12 likewise may be performed by either the copier or printer or the server. More generally, the data processing steps S12 and S14 to S15 may be performed in a distributed manner by several devices. It should also be note that the order of performance of steps S12 and S13 relative to steps S14 to S16 is generally not important.

The authentication stage is described with reference to FIG. 2. The target document is scanned to generate a target grayscale image (step S21). The barcode contained in the target image is extracted and decoded to obtain the information contained therein, including the document ID (step S22). The document ID is then used to retrieve the stored binarized original image having the same document ID from the storage device (step S23). Layout information of the original image is also retrieved in this step. The target grayscale image is binarized (step S24).

Then, the binarized target image is segmented into a number of relatively large blocks (step S25). The segmentation is performed in a similar manner as for the original image. For example, if the original image is segmented into paragraph blocks, then the target image is also segmented into paragraph blocks using the same algorithm. Thus, if the target document contains no alteration or only local alterations (e.g. deletion, insertion or change of words in a relatively isolated manner), the segmentation result for the target image should include the same number of blocks having approximately the same relative positions as in the original image.

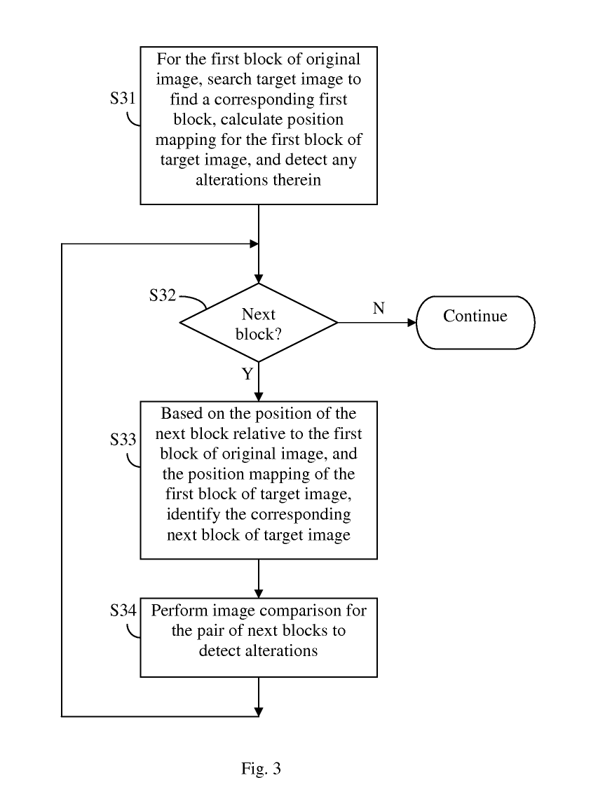

Then, an image comparison process is performed on a block-by-block basis to detect any alternations contained the target image (step S25). In this step, the first pair of blocks of the original and target images is treated differently than subsequent pairs of blocks, and different image comparison methods are used for them. This step is described in more detail with reference to FIG. 3.

Referring to FIG. 3, the first block of the original image is used to search the target image to find a corresponding first block (step S31). The first block is preferably a block located at the top of the original image, but it can be any of the multiple blocks. The search is done by comparing the first block of the original image with each block of the target image until a match is found. In a preferred embodiment, a normalized cross-correlation method is used to compare two blocks (sub-images). Other methods, including image transform based methods, such as comparison of Fourier transform coefficients or wavelet transform coefficients, may also be used. The cross-correlation method calculates a measure of similarity between the block of the original image and the block of the target image, as well as the position mapping for the block of the target image. The measure of similarity is used to determine whether the block of the target image corresponds to the first block of the original image, as well as to determine whether any alteration is present. Two threshold values may be used: If the measure of similarity is greater than a first threshold value, the block of the target image is determined to correspond to the first block of the original image and contains no alterations. If the measure of similarity is less than the first threshold value but greater than a second threshold value, the block of the target image is determined to correspond to the first block of the original image but contains some alterations. If the measure of similarity is less than the second threshold value, the block of the target image is determined not to correspond to the first block of the original image.

The position mapping calculated in step S31 represent the amounts that the first block of the target image must be shifted and/or rotated in order to be aligned with the first block of the original image. In a preferred embodiment, rotation of the target image has been separately corrected in a deskew process (not shown in FIG. 2) performed before the image comparison step S26. In such an embodiment, the position mapping calculated in step S31 only include a shift, and not rotation, of the first block of the target image. If image rotation has not been separately corrected, then the position mapping calculated in step S31 preferably include both shift and rotation.

It can be seen that the searching step S31 accomplished three functions: identifying a corresponding first block in the target image, calculating its position mapping, and detecting any alterations in the first block of the target image.

After the first block is processed, the subsequent blocks of the original and target images can be compared using a different image comparison method than the method used for the first block. For each subsequent block of the original image (step S32), a corresponding block of the target document is identified based on the position of the subsequent block of the original image relative to the first block of the original image, which is obtained from the layout information, as well as the position mapping for the first block of the target image (step S33). More specifically, this step identifies a block of the target image that has a relative position with respect to the first block of the target image substantially equal to the relative position of the subsequent block of the original image with respect to the first block of the original image, and that has substantially the same size as the subsequent block of the original image. The identification does not require any image comparison. This is based on the reasonable assumption that the relative positions among blocks of the target image are approximately the same as the relative positions among blocks of the original image, even though the target image as a whole is shifted and/or rotated relative to the original image. A suitable tolerance such as half the average size of the characters in the block may be used when comparing the positions and sizes of the blocks.

If a corresponding block satisfying the above conditions is not found in the target image, then the target image may be deemed to have been altered.

Once the corresponding block of the target image is identified, an image comparison is carried out for the pair of blocks (step S34). Because the position mapping for the block of the target image are known (they are assumed to be the same as the correction values for the first block of the target image), an image registration calculation is omitted, and the blocks may be compared without using a computationally intensive cross-correlation method. Various methods may be suitable for image comparison in step S34. For example, a simple method calculates a difference image (XOR) of the two sub-images.

Another image comparison method, described in commonly owned U.S. Pat. No. 8,000,528, issued Aug. 16, 2011, involves segmenting the original and target documents into paragraph, line, word and character units, and comparing the two images at progressively lower levers. The paragraph level comparison determines whether the target and original images have the same number of paragraphs and whether the paragraphs have the same sizes and locations (this would be comparable to step S33 of FIG. 3); the line level comparison determines if the target and original images have the same number of lines and whether the lines have the same sizes and locations; etc.

Yet another image comparison method, described in commonly owned U.S. Pat. No. 7,965,894, issued Jun. 21, 2011, involves a two-step comparison. In the first step, the original and target images are divided into connected image components and their centroids are obtained, and the centroids of the image components in the original and target images are compared. Each centroid in the target image that is not in the original image is deemed to represent an addition, and each centroid in the original image that is not in the target image is deemed to represent a deletion. In the second step, sub-images containing the image components corresponding to each pair of matching centroids in the original and target images are compared to detect any alterations.

Yet another image comparison method, described in commonly owned, co-pending U.S. patent application Ser. No. 13/053618, filed Mar. 22, 2011, involves comparing pairs of text characters by analyzing and comparing their shape features such as their Euler numbers, aspect ratios of their bounding boxes, pixel densities, the Hausdorff distance between the two characters, etc.

Steps S33 and S34 are repeated for the next block of the original image until all blocks are processed (step S32).

At various points of the image comparison flow shown in FIG. 3, alterations may be detected. For examine, the target document is determined to have been altered if the target image and the original image contain different numbers of blocks, or if in steps S31 or S33 no block is found in the target document to correspond to the block of the original image, or if in steps S31 and S34 alterations are detected in any block of the target image. The method flow may be designed such that as soon as any alteration is detected, the process terminates with a determination result that the target document is not authentic. Alternatively, the method flow may be designed to continue after alterations are found until the entire document is processed, so that all of the alterations may be detected and can be displayed to the user if desired. These alternative flows are not shown in the drawings but they can be easily implemented by those skilled in the art.

Further, although not shown in the drawings, various post-processing steps may be carried out, such as generating a difference map between the original image and the target image if any alteration is detected, displaying the detection result to the user, etc. Again, these steps may be easily implemented by those skilled in the art.

In the authentication stage, steps S24 to S26 may be performed by the scanner, in which case the scanner can request the original image and layout information from the server or retrieve it directly from the storage device; or they may be performed by the server, in which case the scanner will transmit the target image to the server. Step S22 likewise may be performed by either the scanner or the server. More generally, the data processing steps S22 to S23 and S24 to S26 may be performed in a distributed manner by several devices.

In the methods shown in FIGS. 1 and 2, the segmentation of the original image (step S15) is performed during the document registration stage and the resulting layout information is stored in the storage device. Alternatively (less preferred), the segmentation step may be performed in the authentication stage rather than in the document registration stage.

It will be apparent to those skilled in the art that various modification and variations can be made in the alteration detection method and related apparatus of the present invention without departing from the spirit or scope of the invention. Thus, it is intended that the present invention cover modifications and variations that come within the scope of the appended claims and their equivalents.

What is claimed is:

1. A document authentication method implemented in a data processing system, comprising:
(a) obtaining an original image representing an original document;
(b) segmenting the original image into a plurality of blocks to generate layout information, wherein the layout information includes positions of the plurality of blocks;
(c) obtaining a target image representing a target document;
(d) segmenting the target image into a plurality of blocks;
(e) for a first block among the plurality of blocks of the original image:
(e1) searching the target image to identify a first block of the target image corresponding to the first block of the original image;
(e2) calculating a position mapping for the first block of the target image; and
(e3) detecting any alterations in the first block of the target image; and
(f) for each subsequent block among the plurality of blocks of the original image:
(f1) identifying a subsequent block of the target image corresponding to the subsequent block of the original image based on a position of the subsequent block of the original image relative to the first block of the original image obtained from the layout information and the position mapping for the first block of the target image calculated in step (e2);
(f2) comparing the subsequent block of the original image and the subsequent block of the target image to detect any alterations in the subsequent block of the target image.

2. The method of claim 1, wherein the original image and the target image are binary images, wherein step (a) includes scanning the original document to generate an original grayscale image and binarizing the original grayscale image to generate the original image, and wherein step (c) includes scanning the target document to generate a target grayscale image and binarizing the target grayscale image to generate the target image.

3. The method of claim 2, further comprising, after step (a), printing the original image or the original grayscale image to generate a copy of the original document.

4. The method of claim 1, further comprising:
after step (b), storing the original image and the layout information in a storage device; and
before step (e), retrieving the stored original image and layout information from the storage device.

5. The method of claim 1, wherein each of the plurality of blocks of the original image corresponds to a paragraph of text in the original document, and each of the plurality of blocks of the target image corresponds to a paragraph of text in the original target document.

6. The method of claim 1, wherein steps (e1), (e2) and (e3) are performed using a cross-correlation method.

7. The method of claim 1, wherein step (e1), (e2) and (e3) are performed using a first image comparison method, and where step (f2) is performed using a second image comparison method which is different from the first image comparison method.

8. The method of claim 1, wherein step (f1) is performed without performing image comparison of the subsequent block of the original image with any block of the target image.

9. A computer program product comprising a computer usable non-transitory medium having a computer readable program code embedded therein for controlling a data processing apparatus, the computer readable program code configured to cause the data processing apparatus to execute a document authentication process which comprises:
(a) obtaining an original image representing an original document;
(b) segmenting the original image into a plurality of blocks to generate layout information, wherein the layout information includes positions of the plurality of blocks;
(c) obtaining a target image representing a target document;
(d) segmenting the target image into a plurality of blocks;
(e) for a first block among the plurality of blocks of the original image:
(e1) searching the target image to identify a first block in the target image corresponding to the first block of the original image;
(e2) calculating a position mapping for the first block of the target image; and
(e3) detecting any alterations in the first block of the target image; and
(f) for each subsequent block among the plurality of blocks of the original image:
(f1) identifying a subsequent block of the target image corresponding to the subsequent block of the original image based on a position of the subsequent block of the original image relative to the first block of the original image obtained from the layout information, and the position mapping for the first block of the target image calculated in step (e2);
(f2) comparing the subsequent block of the original image and the subsequent block of the target image to detect any alterations in the subsequent block of the target image.

10. The computer program product of claim 9, wherein the original image and the target image are binary images, wherein step (a) includes obtaining an original grayscale image and binarizing the original grayscale image to generate the original image, and wherein step (c) includes obtaining a target grayscale image and binarizing the target grayscale image to generate the target image.

11. The computer program product of claim 9, wherein the process further comprises:
after step (b), storing the original image and the layout information in a storage device; and
before step (e), retrieving the stored original image and layout information from the storage device.

12. The computer program product of claim 9, wherein each of the plurality of blocks of the original image corresponds to a paragraph of text in the original document, and each of the plurality of blocks of the target image corresponds to a paragraph of text in the original target document.

13. The computer program product of claim 9, wherein steps (e1), (e2) and (e3) are performed using a cross-correlation method.

14. The computer program product of claim 9, wherein step (e1), (e2) and (e3) are performed using a first image comparison method, and where step (f2) is performed using a second image comparison method which is different from the first image comparison method.

15. The computer program product of claim 9, wherein step (f1) is performed without performing image comparison of the subsequent block of the original image with any block of the target image.

16. A computer program product comprising a computer usable non-transitory medium having a computer readable program code embedded therein for controlling a data processing apparatus, the computer readable program code configured to cause the data processing apparatus to execute a document authentication process which comprises:
(a) obtaining an original image representing an original document and associated layout information from a storage device, the layout information defining a plurality of blocks of the original image including positions of the plurality of blocks;
(b) obtaining a target image representing a target document;
(c) segmenting the target image into a plurality of blocks;
(d) for a first block among the plurality of blocks of the original image:
(d1) searching the target image to identify a first block in the target image corresponding to the first block of the original image;
(d2) calculating a position mapping for the first block of the target image; and
(d3) detecting any alterations in the first block of the target image; and
(e) for each subsequent block among the plurality of blocks of the original image:
(e1) identifying a subsequent block of the target image corresponding to the subsequent block of the original image based on a position of the subsequent block of the original image relative to the first block of the original image obtained from the layout information, and the position mapping for the first block of the target image calculated in step (d2);
(e2) comparing the subsequent block of the original image and the subsequent block of the target image to detect any alterations in the subsequent block of the target image.

17. The computer program product of claim 16, wherein the original image and the target image are binary images, and wherein step (b) includes obtaining a target grayscale image and binarizing the target grayscale image to generate the target image.

18. The computer program product of claim 16, wherein each of the plurality of blocks of the original image corresponds to a paragraph of text in the original document, and each of the plurality of blocks of the target image corresponds to a paragraph of text in the original target document.

19. The computer program product of claim 16, wherein steps (d1), (d2) and (d3) are performed using a cross-correlation method.

20. The computer program product of claim 16, wherein step (d1), (d2) and (d3) are performed using a first image comparison method, and where step (e2) is performed using a second image comparison method which is different from the first image comparison method.

21. The computer program product of claim 16, wherein step (e1) is performed without performing image comparison of the subsequent block of the original image with any block of the target image.
